(19) United States
(12) Patent Application Publication
(10) Pub. No.: US 2009/0213795 A1
(43) Pub. Date: Aug. 27, 2009

(54) Communication of Access Information in Wireless Communication System

(75) Inventors: Phillip Barber, McKinney, TX (US); Ronald Xuzhuang Mao, San Diego, CA (US)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/391,080

(22) Filed: Feb. 23, 2009

Related U.S. Application Data
(60) Provisional application No. 61/031,288, filed on Feb. 25, 2008.
(60) Provisional application No. 61/031,286, filed on Feb. 25, 2008.
(60) Provisional application No. 61/031,271, filed on Feb. 25, 2008.
(60) Provisional application No. 61/031,278, filed on Feb. 25, 2008.
(60) Provisional application No. 61/030,882, filed on Feb. 22, 2008.

(51) Int. Cl. H04W 4/00

(52) U.S. Cl. 370/328

(57) ABSTRACT

System and method for providing wireless communications is provided. Communications are established between a mobile station and a base station, and the mobile station is provided a list of network providers that can be accessed via the base station. The list of network providers may include identifiers of the available network service providers or both identifiers and names of the available network service providers, and may be provided as a result of a broadcast message or in response to a request. The mobile station may further request the realm of a visited network service provider in order to properly decorate an EAP authentication information request. By transmitting a properly decorated EAP authentication request, the mobile station can determine the type of authentication to be performed and provide it to the visited network service provider.

This application claims the benefit of U.S. Provisional Application No. 61/031,288, filed on Feb. 25, 2008, entitled “Construction and Use of NSP List TLV in SBC-RSP and SII-ADV,” U.S. Provisional Application No. 61/031,286, filed on Feb. 25, 2008, entitled “Construction and Use of Auth Type for Single EAP TLV in SBC-REQ,” U.S. Provisional Application No. 61/031,271, filed on Feb. 25, 2008, entitled “Construction and Use of Verbose NSP Name List TLV in SBC-RSP and SII-ADV,” U.S. Provisional Application No. 61/031,278, filed on Feb. 25, 2008, entitled “Construction and Use of Visited NSP Realm TLV in SBC-RSP,” and U.S. Provisional Application No. 61/030,882, filed on Feb. 22, 2008, entitled “Construction and Use of Visited NSP TLV in the SBC-REQ,” all of which are hereby incorporated herein by reference.

### TECHNICAL FIELD

The present invention relates generally to wireless communications systems and, more particularly, to communicating network access information from a network element to a mobile station.

### BACKGROUND

The drive for wireless communications is to allow for greater levels of roaming and to allow for seamless roaming. Myriad issues, such as hand-off between providers, authentication, communication system capabilities and limitations, become increasingly important when roaming, particularly global roaming, is contemplated. Even more attention must be paid when dealing with telecommunication systems and protocols, e.g., WiMAX, that allows for multiple providers to share the same access point/access network. This significantly reduces the costs of the radio network for the providers and makes for more efficient use of limited radio spectrum. In order to implement such a system, however, the mobile station must be informed of the providers that are available on a visited network.

Generally, wireless communications systems, such as WiMAX, have a home network services provider and a visitor network services provider. The home network services providers are the network services providers with which customers enter service agreements. When roaming or utilizing network services outside of the service area of the home network service provider associated with the mobile station (MS), a visitor network services provider provides network access to the MS under an agreement between the home network service provider and the visitor network services provider.

During network detection and selection (the time period in which the MS detects the available networks and selects a particular network), the MS must know the identifiers associated with the network service providers providing service at the location of the MS in order to make a selection of which operator to use, if any. The network service provider identifier, however, is typically a number or other identifier, such as a three byte identifier, that is not meaningful to a user, particularly when using manual selection methods.

Furthermore, during network detection and selection while the MS is roaming, the visitor network services provider must determine the authentication policy in order to formulate an authentication procedure for the MS before allowing the MS to access the network. This problem may be particularly problematic because standards, such as the 802.16e-2005 standard, provide that the authentication policy information supplied by the MS is terminal capability only, and does not necessarily reflect the actual policy for the MS subscription at the home network services provider. As a result, the information available to the MS and the visitor network services provider is inadequate for the visitor network services provider to make an effective determination as to the authentication policy to enforce. For example, the MS providing a simple declaration of “Single-EAP” (extended authentication protocol) may be inadequate as the visitor network services provider is unaware if the “Single-EAP” is for device authorization or user authorization. Without additional information, the visitor network services provider may inappropriately indicate for the MS to perform “Double-EAP,” when “Single-EAP” is required. That is, if the MS policy at its home network services provider is “Single-EAP, Device Authentication,” and the visitor network services provider authentication policy is “Device Authentication,” then the visitor network services provider should enforce “Single-EAP, Device Authentication” for the authentication policy. Since the visitor network services provider does not know if the home network services provider authentication policy is device authentication or user authentication, however, the visitor network services provider may assume that the authentication policy for the home network services provider is user authentication and proscribe “Double-EAP.”

To further exacerbate the issue, the MS does not have sufficient information to construct a properly decorated EAP information request such that the visitor network service provider may determine the correct authentication policy to enforce.

Accordingly, there is a need for a system and a method for sharing network access information between mobile stations and network elements.

### SUMMARY OF THE INVENTION

These and other problems are generally solved or circumvented, and technical advantages are generally achieved, by preferred embodiments of the present invention which provides a wireless communications system and method.

In accordance with an embodiment of the present invention, a method and computer program product for establishing network access to a communications network are provided. Communications are established between a mobile station and a base station. After communications are established, the mobile station is provided a list of network providers that can be accessed via the base station. The list of network providers may be provided as a result of a broadcast message or in response to a request. The list of network providers may include identifiers of the available network service providers or both identifiers and names of the available network service providers.

In embodiments of the present invention, the mobile station may further request the realm of a visited network service provider in order to properly decorate an EAP authentication information request. By transmitting a properly decorated EAP authentication request, the mobile station can determine the type of authentication to be performed and provide it to the visited network service provider.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a network diagram of a communications system in accordance with an embodiment of the present invention;

FIGS. 2a and 2b is a message flow diagram and a message that may be broadcasted to mobile stations to provide identifiers of network service providers in accordance with an embodiment of the present invention;

FIGS. 3a and 3b is a message flow diagram and a message that may be broadcasted to mobile stations to provide identifiers and names of network service providers in accordance with an embodiment of the present invention;

FIGS. 4a-4e is a message flow diagram and messages that may be used to allow the mobile station to request information regarding the identity of available network service providers in accordance with an embodiment of the present invention;

FIG. 5 is a process flow diagram illustrating a process that may be used for the mobile station to connect to a network service provider;

FIGS. 6a-6c is a message flow diagram and messages that may be used to allow the mobile station to request realm information on a network service provider in accordance with an embodiment of the present invention; and

FIGS. 7a and 7b is a message flow diagram and a message that may be used to allow the mobile station to inform a network service provider of the type of authentication to be used in accordance with an embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

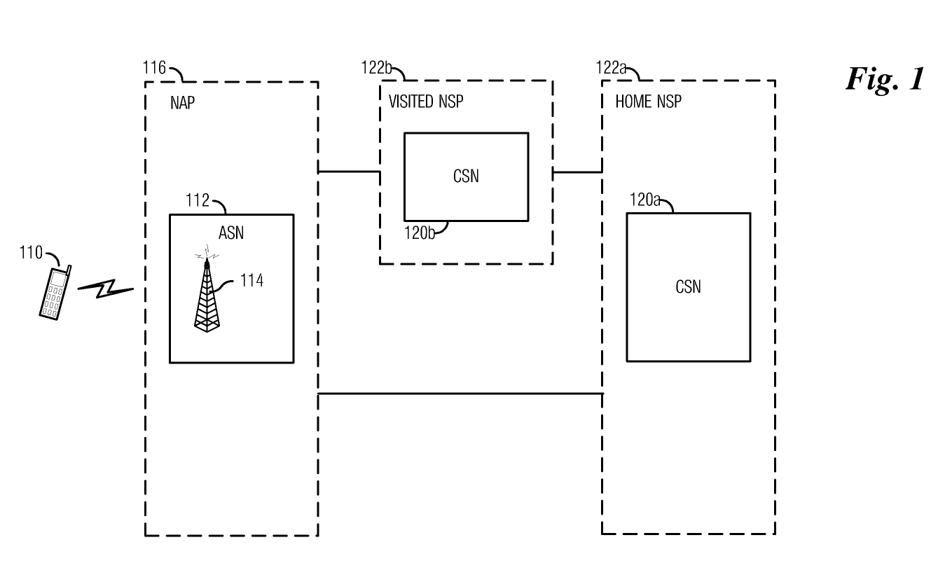

With reference now to FIG. 1, there is shown network diagram of a communications system embodying features of the present invention. It should be noted that embodiments of the present invention are described in terms of WiMAX as defined by the IEEE 802.16 standard and WiMAX Forum Network Reference Model for illustrative purposes only, and accordingly, embodiments of the present invention may equally apply to other types of communications systems.

Generally, the mobile station (MS) 110 connects via a wireless link to a base station (BS) 114 of an access services network (ASN) 112, which provides network access services and interconnectivity capabilities to the MS 110, including providing relay services for IP connectivity, radio resource management, multicast and broadcast control intra-ASN mobility, inter-ASN mobility, paging and location management, authentication and authorization capabilities, accounting, quality of service, and the like. The ASN 112 is owned and operated by a network access provider (NAP) 116. Within any one geographical area, it is possible to have a plurality of ASNs providing service of the same or different types, such as WiMAX, cellular, Bluetooth, or the like. Additionally, it is possible to have many NAPs operating in any one area. As explained in greater detail below, the MS 110 determines to which ASN and NAP to connect based upon, inter alia, the subscription under which the MS user is operating, as well as the business agreements under which the NAP is operating in the specific area.

The ASN 112 provides connectivity to a connectivity services network (CSN), such as CSNs 120a and 120b. The CSNs 120a and 120b are owned and operated by different network service providers (NSP), such as NSPs 122a and 122b, and provide core network services, such as connectivity services to other networks and/or other network elements, e.g., other mobile stations, landline terminals, data servers, or the like. The NSP 122a is referred to as a home NSP (HNSP) and is the NSP to which the subscriber has a contract with to provide wireless services. On the other hand, the NSP 122b is referred to as a visited NSP (VNSP) and is an NSP to which the subscriber does not have a contract with, but the HNSP 122a of the subscriber has a business agreement such that the VNSP 122b agrees to provide core network services to the subscriber for the HNSP 122a when the subscriber is roaming outside of the HNSP service area. Accordingly, when the HNSP has a direct business relationship with the NAP, then an intermediary VNSP is unnecessary; but when the HNSP does not have a direct business relationship with the NAP, then the HNSP may use an indirect business relationship in order to provide service to its supported MSs, where the indirect business relationship involves an intermediary VNSP that has a direct business relationship with the NAP to which the MS subscribed to the HNSP is attempting to access service, and the VNSP has a business relationship with the HNSP.

It should be noted that the network diagram illustrated in FIG. 1 is provided for illustrative purposes only, and as a result, the network diagram does not show all of the elements that may be present in a wireless communications system. For example, the wireless communications system may include an authentication, authorization and accounting (AAA) server, location registers, routers, gateways, and the like. Furthermore, each element may include additional components. For example, the ASN may include a handover function, a context function, an AAA client, a radio resource management function, a paging controller, a location register, a key distributor, an upper sync executer, a synchronization controller, and the like, and the CSN may include an AAA function, a Policy Function (PF), a DHCP Server, and the like. Additional information regarding these elements, and other elements in the network, may be found in IEEE 802.16 standard (including IEEE 802.16-2004, IEEE 802.16e-2005, IEEE 802.16g-2007, IEEE802.16Rev2/D3(2008), and IEEE 802.16Rev2/D9(2009)) and in the WiMAX Forum Network Architecture (including Stage 2: Architecture Tenets, Reference Model and Reference Points, Release 1, Version 1.2, Stage 3: Detailed Protocols and Procedures, Release 1, Version 1.2, and Stage 3: Detailed Protocols and Procedures, WMF-T33-001-R010v04_Network-Stage 3-Base, Release 1.0, Version 4.0), all of which are incorporated herein by reference.

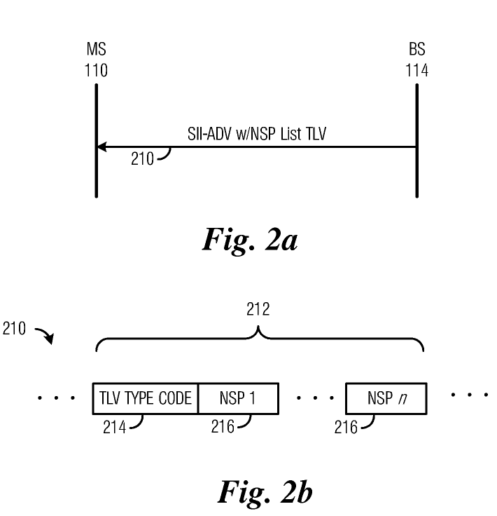

FIG. 2a is a message flow diagram illustrating a message that may be sent by a base station to a mobile station in accordance with an embodiment of the present invention. As noted above, the MS 110 needs a list of NSPs providing service within the area to allow the MS 110 to select an NSP to which to attempt to connect for accessing core network services. In the embodiment illustrated in FIG. 2, and in the context of IEEE 802.16g, the Service Identity Information—Advertise (SII-ADV) message 210 is modified to include an NSP List. The SII-ADV 210 is a broadcast message that is transmitted periodically and may be detected by any listening device capable of decoding the message. Thus, by including a NSP List in a broadcast message such as the SII-ADV 210, a listening device will be able to determine which NSPs provide service within the current area.

In an embodiment, the SII-ADV message 210 is modified as illustrated in FIG. 2b to include the NSP List in an NSP List TLV 212. As is known in the art, TLV is a type/length/value formatting scheme that adds a tag to a parameter, e.g., TLV Type Code 214, that indicates the parameter type, encoding rules, and length. The TLV Type Code 214 is followed by one to n number of NSP Identifiers (IDs) 216. Each NSP ID 216 is an identifier that uniquely identifies an NSP that is providing service at the current location of the MS 110. The NSP IDs 216 may be, for example, 24-bit identifiers.

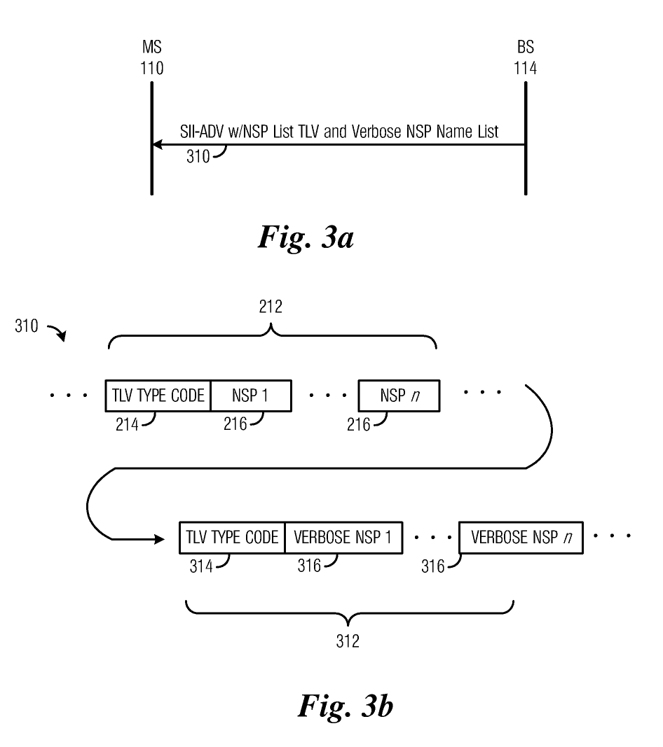

Because the NSP IDs 216 are typically a numeric value, the NSP IDs 216 may not be very meaningful to a user of the MS 110, particularly in situations in which the user is attempting a manual selection or hot-lining entry to gain access. In these cases, it may be desirable to include an optional Verbose NSP Name List in the SII-ADV message 310 as indicated in FIG. 3a. The Verbose NSP Name List provides a more meaningful identifier for the one or more of the NSP IDs 216 included in the NSP List TLV 212.

An embodiment of the SII-ADV message 310 modified to include both the NSP List TLV 212 as well as a Verbose NSP Name List TLV 312 as illustrated in FIG. 3b. Similar to the NSP List TLV 212, the Verbose NSP Name List TLV 312 includes a TLV Type Code 314 that identifies the field as a Verbose NSP Name List TLV. The TLV Type Code 314 is followed by one or more Verbose NSP Names corresponding to the respective NSP IDs contained in the NSP List TLV 212.

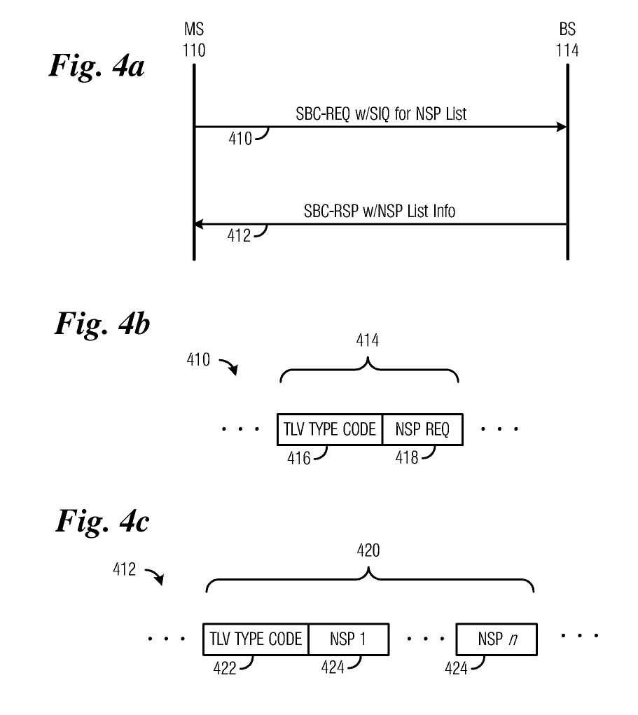

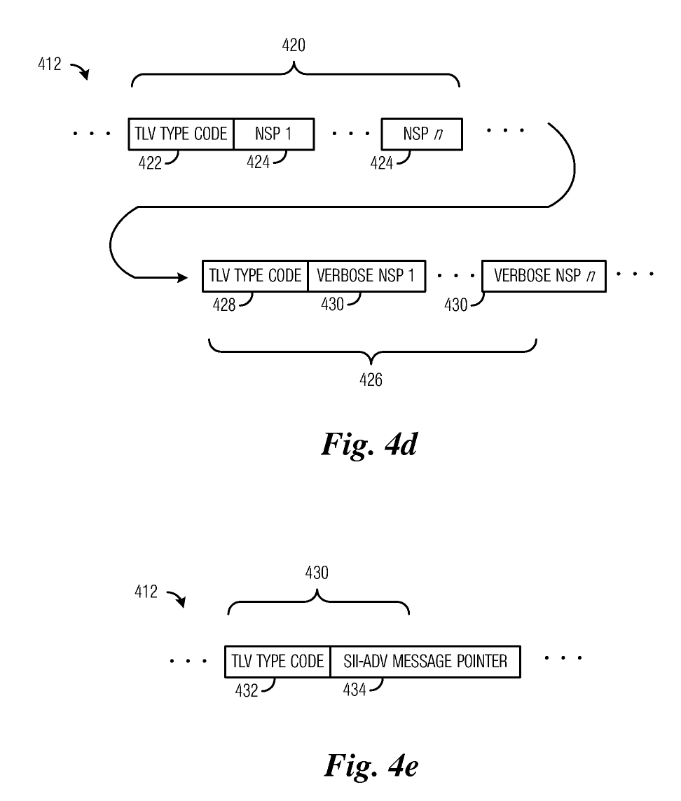

FIG. 4a illustrates a Service Basic Capabilities—Request (SBC-REQ) message 410 that allows the NSP ID list to be retrieved in accordance with another embodiment of the present invention. In some instances, the MS 110 may not detect the SII-ADV message, such as the SII-ADV messages 210 or 310, or the SII-ADV message may not contain the necessary information. In these situations, it may be desirable to allow the MS 110 to request the NSP Id list from the network, represented by the BS 114.

In the embodiment illustrated in FIG. 4a, the SBC-REQ message 410 includes a Service Information Query (SIQ) TLV, which indicates that the MS 110 is requesting NSP information corresponding to the current location of the MS 110. An embodiment of the SBC-REQ message 410 is illustrated in FIG. 4b. The SBC-REQ message 410 includes an SIQ TLV 414 embedded therein. The SIQ TLV 414 includes a TLV Type Code 416 identifying the field as an SIQ, followed by an NSP Request 418. The NSP Request 418 is a field that specifies the information desired by the MS 110. In an embodiment, the NSP Request 418 is a multiple bit field that includes one bit that indicates that the MS 110 is requesting transmittal of the NSP List TLV for the list of NSP IDs supporting the communications network at the current location of the MS 110. Another bit may be used to indicate that the MS 110 is requesting transmittal of the Verbose NSP Name List TLV in addition to the NSP List TLV.

As illustrated in FIG. 4a, in response the BS 114 transmits an SBC—Response (SBC-RSP) message 412 including either the requested NSP information itself or an indication of when the BS 114 will be transmitting the SII-ADV message that includes the requested NSP information. Embodiments of the first situation in which the SBC-RSP message 412 includes the requested NSP information itself is illustrated are FIGS. 4c and 4d.

In particular, FIG. 4c illustrates the embodiment in which the unicast SBC-RSP message 412 includes an NSP List TLV 420, transmitted in response to the SBC-REQ message 410 that includes the NSP Request 418 that indicates the MS 110 is requesting only the NSP ID List. The NSP List TLV 420 may have a similar format as the NSP List TLV 212 discussed above with reference to FIG. 2b, except that in this case the NSP List TLV 420 is included in the SBC-RSP message 410 rather than the SII-ADV message 210. The NSP List TLV 420 includes TLV Type Code 422 followed by one to n number of NSP IDs 424. Each NSP ID 424 is an identifier that uniquely identifies an NSP that is providing service at the current location of the MS 110.

FIG. 4d illustrates the embodiment in which the SBC-RSP message 412 includes an NSP List TLV 420 and a Verbose NSP Name List TLV 426, transmitted in response to the SBC-REQ message 410 that includes the NSP Request 418 that indicates the MS 110 is requesting both the NSP ID List and the Verbose NSP ID List. As mentioned above, the NSP IDs are generally numeric values that are not meaningful to a user, and accordingly, it may be desirable to also retrieve the verbose names corresponding to the NSP IDs. The Verbose NSP Name List TLV 426 includes a TLV Type Code 428 that identifies the field as a Verbose NSP Name List. The TLV Type Code 428 is followed by one or more Verbose NSP Names 430 corresponding to the respective NSP IDs contained in the NSP List TLV 420.

FIG. 4e illustrates an example of an embodiment in which the BS 114 responds to the SBC-REQ message 410 by providing a pointer to when the next SII-ADV message that includes the requested NSP information, such as the SII-ADV message 210 discussed above with reference to FIG. 2, will be transmitted. In this embodiment, the SBC-RSP message 412 includes a SII-ADV message pointer TLV 430, which includes a TLV Type Code 432 that identifies the field as a SII-ADV message pointer TLV followed by a SII-ADV message pointer 434. The SII-ADV message pointer 434 may be any type of value that indicates the point of transmission of an SII-ADV message. In an embodiment, the SII-ADV message pointer 434 indicates the frame number of the frame in which the SII-ADV message that includes the requested message will be transmitted.

As one of ordinary skill in the art will appreciate, the systems and methods discussed above provide NSP information on the MS 110, thereby allowing the MS 110 to determine to which NSP to connect.

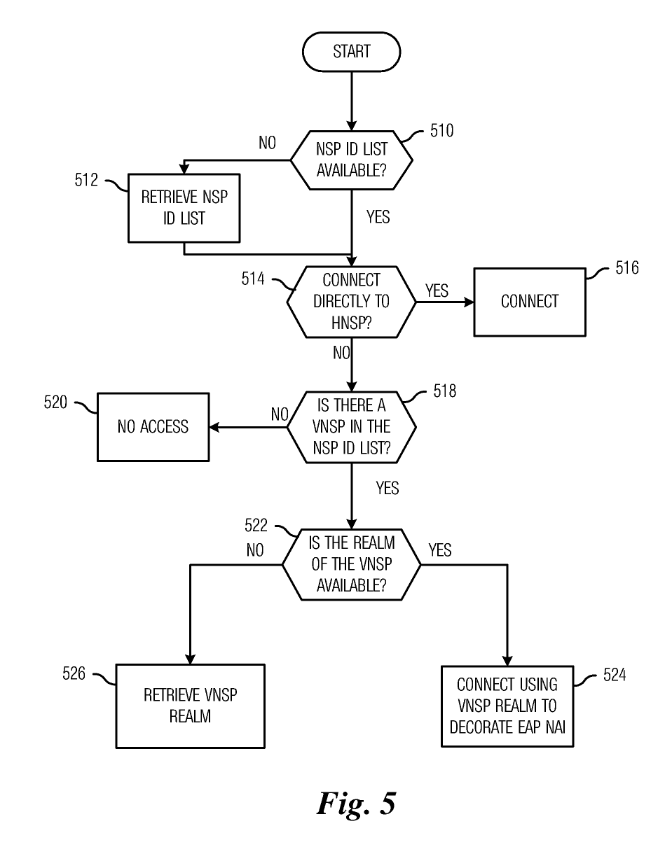

FIG. 5 is a flow chart illustrating a process of connecting the MS 110 to a communications network in accordance with an embodiment of the present invention. The process begins in step 510, wherein the MS 110 determines whether or not the NSP ID List is available on the MS 110. This determination may be performed by the MS 110 by testing an NAP specific NSP Change Count TLV value stored in the MS 110 with the value currently broadcast by the NAP as part of the Downlink Channel Descriptor (DCD) channel encodings. If the NSP Change Count value is the same, and the MS 110 has stored NSP ID List associated with that NSP Change Count value, then the NSP List stored on the MS for the detected NAP is current and valid.

If the NSP Change Count value is different, then the MS 110 may retrieve the NSP ID List or both the NSP ID List and the Verbose NSP Name List from the communications network as discussed above with reference to FIGS. 2a-4e.

If the NSP List is available, or after retrieving the NSP List in step 512, the process continues to step 514, wherein the MS 110 determines whether or not the MS 110 is able to connect directly to the HNSP, such as the case may be when the user is not roaming or the NSP ID of the HNSP is in the advertised NSP ID List of the detected NAP. If the MS 110 is currently in the service area for the HNSP, then the MS 110 may connect directly to the HNSP as indicated in step 516.

Otherwise, the MS 110 determines whether or not there is a VNSP in the NSP ID List that has an agreement with the HNSP that allows the MS 110 to gain access to core network services via the VNSP, such as when the NSP ID of the VNSP is in the advertised NSP ID List of the detected NAP, and the VNSP is in the stored table. In an embodiment, the MS 110 has an HNSP/VNSP relationship table that identifies which VNSPs may be used to gain access to the core network. The HNSP/VNSP relationship table may be stored on the MS 110 by any appropriate method, such as programming upon purchase of the MS 110, downloading upon power-up or some other event, periodically downloading/updating, or the like.

If the MS 110 determines that there is not an NSP in the NSP ID List that qualifies as a VNSP, then no access is available and the MS 110 is not able to gain access to the core network services through the detected NAP.

If the MS 110 determines that there is an NSP in the NSP ID List that qualifies as a VNSP, then processing proceeds to step 522, wherein a determination is made whether the VNSP realm is known. In an embodiment, the VNSP realm is a variable-length string that corresponds to the VNSP ID that the MS intends to use as a conduit for authentication to MS home network, e.g., the HNSP. One such example of a realm that may be used in accordance with an embodiment of the present invention is the Network Access Identifier as specified in IETF RFC 4282 and/or WMF-T33-001-R010v04_Network-Stage3-Base, which are incorporated herein by reference. As discussed above, during network detection and selection, the operator network may not have adequate information to formulate an appropriate SBC-RSP for the negotiated authentication policy. Specifically, unless the MS declares its destination NSP ID in SBC-REQ, the operator network does not know which VNSP policy to apply to determine effect on negotiated authentication policy for that specific MS during that initial network entry event.

Additionally, some systems, such as the IEEE 802.16e-2005 standard, provides that the authentication policy information supplied by the MS during SBC-REQ is terminal capability only, and does not reflect the actual policy for the MS subscription at the HNSP. This information is inadequate for the VNSP to make effective determination as to the correct authentication policy to enforce. Further, if the MS simply provides a declaration of “Single-EAP,” the VNSP does not know if the “Single-EAP” is for device authorization or user authorization. Without additional information, the VNSP may inappropriately indicate for the MS to perform “Double-EAP,” when “Single-EAP” is required. That is, if the MS policy at its HNSP is “Single-EAP, Device Authorization,” and the VNSP authentication policy is “Device Authentication,” then the VNSP should enforce “Single-EAP, Device Authentication” for the policy, but because VNSP does not know if the MS HNSP policy is for device authentication or user authentication, the VNSP may assume that the HNSP policy is for user authentication and proscribe “Double-EAP.”

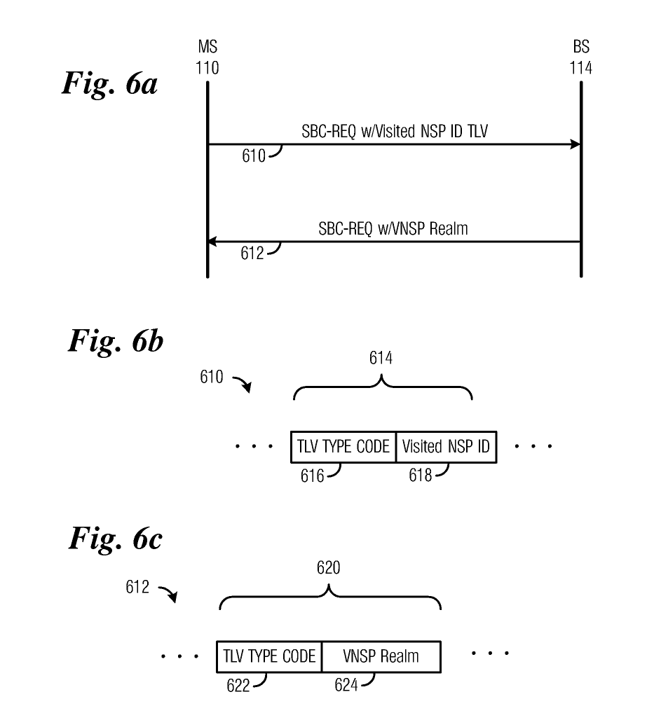

FIG. 6a illustrates a Service Basic Capabilities—Request (SBC-REQ) message 410 that allows the MS 110 to request the VNSP realm in accordance with an embodiment of the present invention. The SBC-REQ message 610 includes a Visited NSP ID, which indicates that the MS 110 is requesting the VNSP realm corresponding to the VNSP ID included in the VNSP ID TLV of the SBC-REQ message 610. An embodiment of the SBC-REQ message 610 is illustrated in FIG. 6b. The SBC-REQ message 610 includes a Visited NSP ID TLV 614 embedded therein. The Visited NSP ID TLV includes a TLV Type Code identifying the field as a Visited NSP ID TLV, followed by a Visited NSP ID 618. The Visited NSP ID 618 identifies the VNSP for which the VNSP realm is being requested.

In response, the BS 114 transmits an SBC—Response (SBC-RSP) message 612 including a Visited NSP Realm TLV 620, which includes TLV Type Code 622 that identifies the field as a Visited NSP Realm TLV and the Visited NSP Realm 624 as illustrated in FIG. 6c.

Retrieval of the VNSP realm as discussed above allows the MS to decorate a Network Access Identifier (NAI) of an EAP Information Request such that the network can properly identify the VNSP to be used to gain access to the HNSP. In this manner, the MS 110 uses the VNSP Realm to declare the intended route for the MS EAP authentication through the VNSP, to the HNSP. The NAP, VNSP, and HNSP use this information to determine the impact on the network side for the specified EAP method and NAP signaled required authentication method.

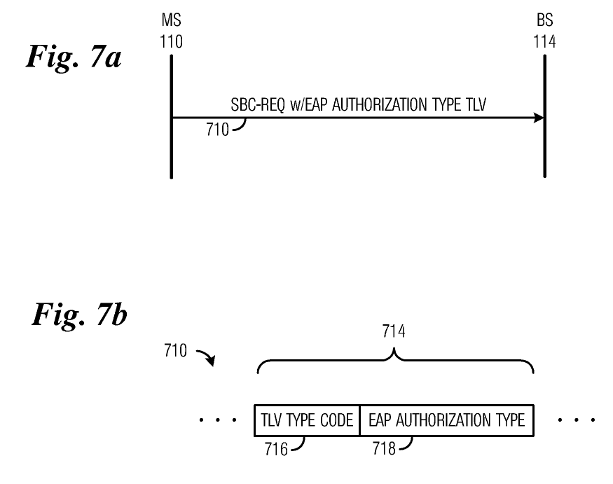

FIG. 7a is a message flow diagram illustrating a message that may be sent by the MS 110 to the BS 114 indicating the type of authentication in the Single EAP required by the MS in accordance with an embodiment of the present invention. As noted above, the type of the Single EAP may be either device authentication or user authentication. The SBC-REQ 710 illustrated in FIG. 7a is designed to notify the BS 114 which type of authentication is required for authentication with the HNSP.

In an embodiment, the SBC-REQ message 710 is modified as illustrated in FIG. 7b to include the Authentication Type in an Auth Type for Single EAP TLV 714. The Auth Type for Single EAP TLV 714 includes a TLV Type Code 716 followed by an Authentication Type value 718. The Authentication Type value 718 may be, for example, a multi-bit field such that one bit indicates device authentication and another bit indicates user authentication.

One of ordinary skill in the art will appreciate that techniques discussed above allows the MS to retrieve information and to inform the network regarding the policies of the MS and the HNSP. In particular, the techniques discussed above allows the MS to identify the VNSPs by ID as well as a more user friendly verbose name, thereby providing more meaningful identification information to the user, particularly when attempting hot-lining to a particular network.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for establishing network access to a communications network, the method comprising:
establishing communications between a mobile station and a base station; and
providing to the mobile station a list of network providers that can be accessed via the base station.

2. The method of claim 1, wherein the providing is performed at least in part by unicasting or broadcasting a message, the message including the list of network providers.

3. The method of claim 1, wherein the list of network providers includes a list of network provider identifiers.

4. The method of claim 1, wherein the list of network providers includes a list of names of the network providers.

5. The method of claim 1, wherein the providing is performed at least in part by broadcasting a message, the message including a change indicator for changes to the list of network providers.

6. The method of claim 1, further comprising providing to the base station from the mobile station a request for the list of network providers, and wherein the providing the list of network providers is performed in response to the request.

7. The method of claim 6, wherein the providing includes providing to the mobile station a pointer to when a message including the list of network providers will be transmitted by the base station.

8. The method of claim 1, wherein the communications between the mobile station and the base station are performed in accordance with an IEEE 802.16 protocol.

9. The method of claim 1, further comprising providing to the mobile station a realm of at least one of the network providers.

10. A computer program product for communicating with a mobile station, the computer program product having a medium with a computer program embodied thereon, the computer program comprising computer program code for:
providing a list of identifiers of network providers that are available to provide access services to the mobile station.

11. The computer program product of claim 10, further comprising providing a list of names of the network providers.

12. The computer program product of claim 10, wherein the providing is performed at least in part by unicasting or broadcasting a message that includes the list of identifiers.

13. The computer program product of claim 10, wherein the providing is performed at least in part by broadcasting a message that includes a change indicator for changes to the list of identifiers.

14. The computer program product of claim 10, further comprising receiving a request for the list of identifiers and wherein the providing is performed in response to the request.

15. The computer program product of claim 14, wherein the providing is performed at least in part by providing an indication when the list of identifiers is to be transmitted.

16. The computer program product of claim 10, further comprising providing a realm of at least one of the network providers.

17. A computer program product for communicating with a base station, the computer program product having a medium with a computer program embodied thereon, the computer program comprising computer program code for:
receiving a list of identifiers of network providers that are available to provide access services to a mobile station.

18. The computer program product of claim 17, wherein the list of identifiers is received via a unicast or broadcast message.

19. The computer program product of claim 17, further comprising transmitting a request for the list of identifiers.

20. The computer program product of claim 17, wherein the list of identifiers includes names of the network providers corresponding to the identifiers.

21. The computer program product of claim 17, further comprising transmitting a request for a realm of at least one of the network providers.

22. The computer program product of claim 17, further comprising transmitting an authentication type to be used for authentication.
